(19) United States
(12) Patent Application Publication
(10) Pub. No.: US 2013/0302239 A1
(43) Pub. Date: Nov. 14, 2013

(54) METHOD FOR MAKING A CHALCOPYRITE-TYPE COMPOUND

(71) Applicants: Chung-Chi JEN, Kaohsiung City (TW); Bang-Yen CHOU, Kaohsiung City (TW); Juo-Hao LI, Kaohsiung City (TW); Wen-Hao YUAN, Kaohsiung City (TW); Chiu-Kung HUANG, Kaohsiung City (TW); Jun-Shing CHIOU, Kaohsiung City (TW); Tzo-Ing LIN, Kaohsiung City (TW)

(72) Inventors: Chung-Chi JEN, Kaohsiung City (TW); Bang-Yen CHOU, Kaohsiung City (TW); Juo-Hao LI, Kaohsiung City (TW); Wen-Hao YUAN, Kaohsiung City (TW); Chiu-Kung HUANG, Kaohsiung City (TW); Jun-Shing CHIOU, Kaohsiung City (TW); Tzo-Ing LIN, Kaohsiung City (TW)

(21) Appl. No.: 13/467,577

(22) Filed: May 9, 2012

(51) Int. Cl. C01B 19/00

(52) U.S. Cl. 423/508

(57) ABSTRACT

A method for making a chalcopyrite-type compound includes reacting a reaction mixture in a solvent under a reaction temperature and a reaction pressure to form the chalcopyrite-type compound. The reaction mixture includes at least one first compound and at least one second compound. The first compound contains M¹ and A. The reaction temperature ranges from 130-280° C. and the reaction pressure is greater than 3 Kg/cm². The second compound contains M² and A. M¹ is selected from Cu, Au, Ag, Na, Li and K, M² is selected from In, Ga, Al, Ti, Zn, Cd, Sn, Mg, and combinations thereof, and A is selected from S, Se, Te, and combinations thereof.

### BACKGROUND OF THE INVENTION

1. Field of the Invention

This invention relates to a method that involves reacting a reaction mixture in a solvent under a high temperature and a high pressure condition to make a chalcopyrite-type compound.

2. Description of the Related Art

Chalcopyrite-type compounds, such as CuInSe₂, and Cu(InₓGa₁₋ₓ) (Se_{y}S_{2-y}), and Cu(InₓAl₁₋ₓ) (Se_{y}S_{2-y}) are used in the production of a semiconductor absorption layer of a solar cell due to their high optoelectric efficiency and low cost. The amount of impurities, such as the carbon content, contained in the chalcopyrite-type compound has a significantly adverse effect on the optoelectric efficiency thereof. It is desirable to manufacture a chalcopyrite-type compound having a low impurity content.

Bin Li et al. (Adv. Mater., 1999, 11, No. 17, 1456-1459) disclose a solvothermal synthesis method for making CuInSe₂ nano-materials. The method involves reacting a mixture of CuCl₂.2H₂O, InCl₃.4H₂O and Se powder in a solvent of ethylenediamine at a temperature of 180° C. for 15 hr to form a precipitate. The precipitate thus formed is rinsed with an aqueous solution containing water and ethanol so as to remove by-product from the precipitate, followed by drying so as to form the chalcopyrite-type compound powder having a structure of a chalcopyrite phase. The chalcopyrite-type compound thus formed has a high carbon impurity content.

U.S. Pat. No. 7,591,990 discloses a process for making a chalcopyrite-type compound of formula M³M¹A₂, where M¹ can be selected from Al³⁺, Ga³⁺, In³⁺, etc., M³ can be selected from Cu⁺, Ag⁺, etc., and A can be selected from S, Se, and Te. The process comprises reacting a compound of formula M³X with a compound of formula M²M¹A₂ in a coordinating solvent so as to form the chalcopyrite-type compound of formula M³M¹A₂, where X can be halogen atom and M² can be Li⁺, Na⁺, K⁺, etc. The aforesaid process requires preparation of a ternary compound M²M¹A₂ as the starting material, which is more complicated as compared to a binary compound. Moreover, the reaction product of the chalcopyrite-type compound thus formed also has a relatively high impurity content. Experiments have shown that the chalcopyrite-type compound thus formed has a carbon impurity content of about 4.3 wt %.

In a co-pending U.S. patent application Ser. No. 13/009,918, the inventors have disclosed a method for making a chalcopyrite-type compound. The method comprises reacting a reaction mixture in a solvent under reflux condition to form the chalcopyrite-type compound. The reaction mixture includes at least one first compound and at least one second compound. The first compound contains M¹ and A The second compound contains M² and A. M¹ is selected from Cu, Au, Ag, Na, Li and K, M² is selected from 1n, Ga, Al, Ti, Zn, Cd, Sn, Mg, and combinations thereof, and A is selected from S, Se, Te, and combinations thereof.

### SUMMARY OF THE INVENTION

Therefore, an object of the present invention is to provide a method for making a chalcopyrite-type compound that can overcome at least one of the aforesaid drawbacks associated with the prior art.

According to the present invention, a method for making a chalcopyrite-type compound comprises reacting a reaction mixture in a solvent under a reaction temperature and a reaction pressure to form the chalcopyrite-type compound. The reaction temperature ranges from 130-280° C. and the reaction pressure is greater than 3 Kg/cm². The reaction mixture includes at least one first compound and at least one second compound. The first compound contains M¹ and A The second compound contains M² and A. M¹ is selected from Cu, Au, Ag, Na, Li and K, M² is selected from In, Ga, Al, Ti, Zn, Cd, Sn, Mg, and combinations thereof, and A is selected from S, Se, Te, and combinations thereof.

### BRIEF DESCRIPTION OF THE DRAWINGS

Other features and advantages of the present invention will become apparent in the following detailed description of the preferred embodiment of this invention, with reference to the accompanying drawings, in which:

FIG. 1 shows an X-ray diffraction pattern of the final product of Example 1 made by the method of the preferred embodiment of this invention;

FIG. 2 shows an X-ray diffraction pattern of the final product of Example 2 made by the method of the preferred embodiment;

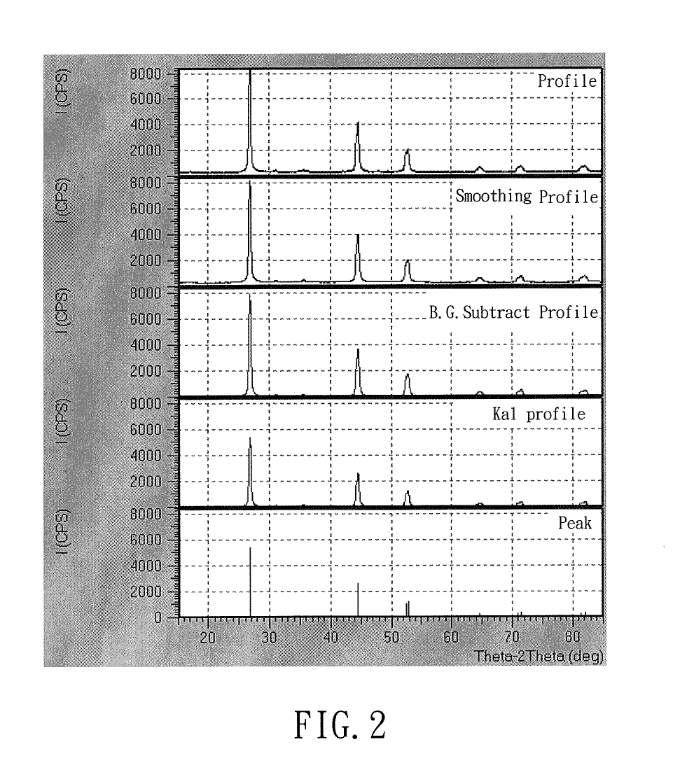

FIG. 3 shows an X-ray diffraction pattern of the final product of Example 3 made by the method of the preferred embodiment;

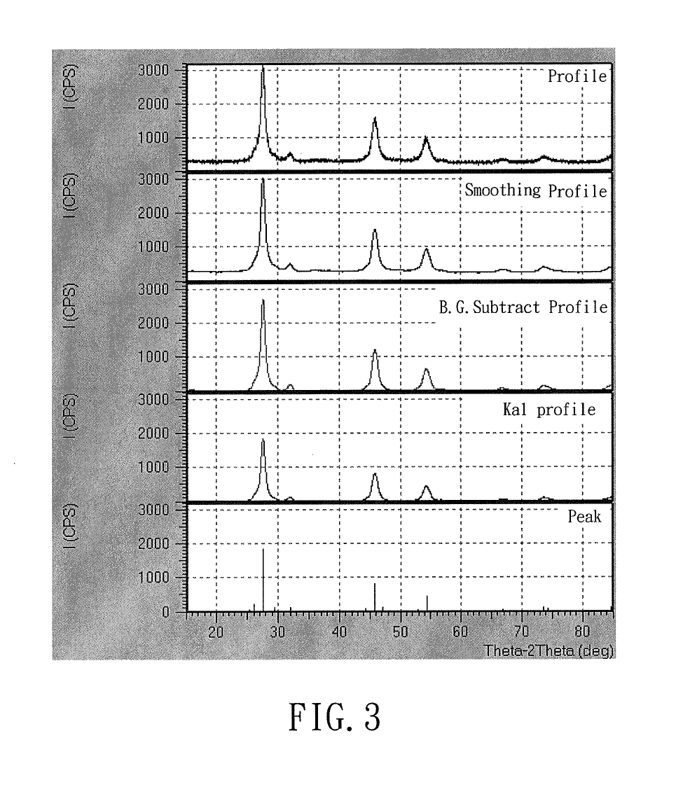

FIG. 4 shows an X-ray diffraction pattern of the final product of Example 4 made by the method of the preferred embodiment;

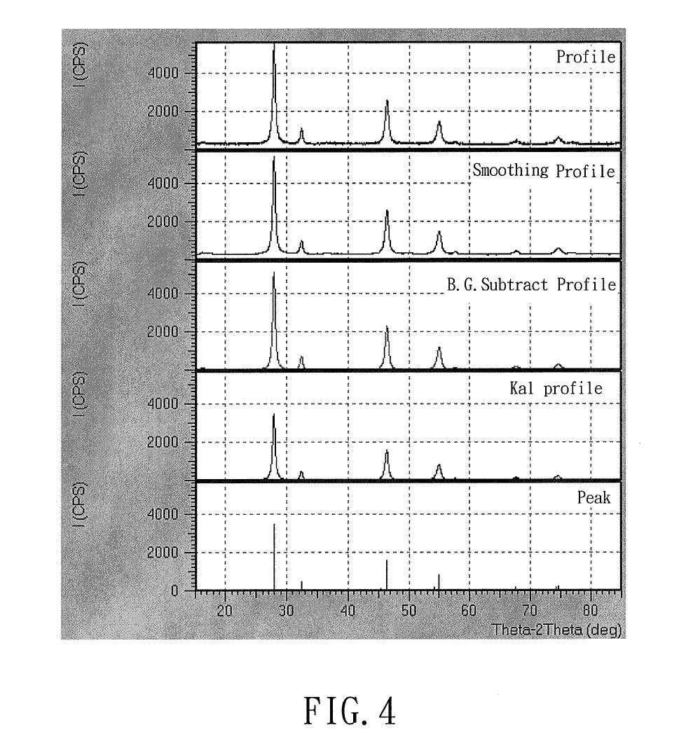

FIG. 5 shows an X-ray diffraction pattern of the final product of Example 5 made by the method of the preferred embodiment;

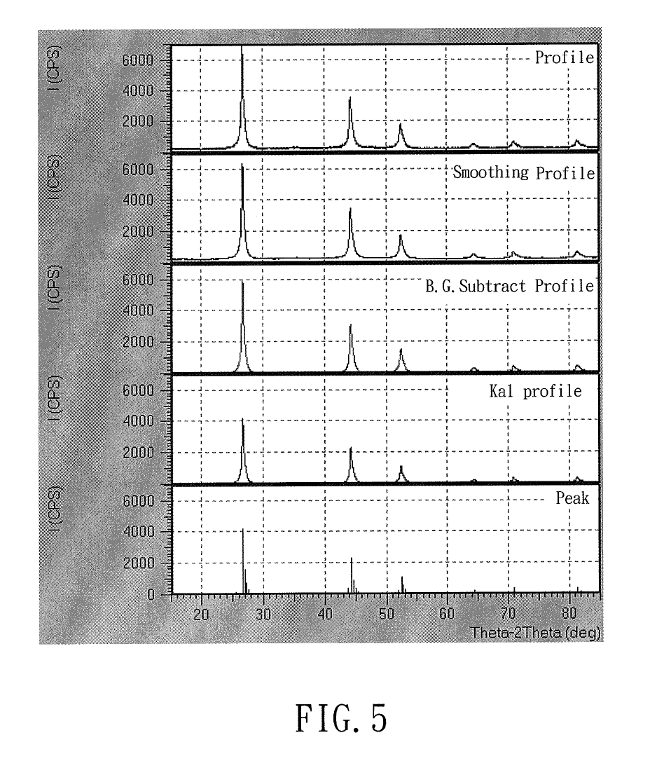

FIG. 6 shows an X-ray diffraction pattern of the final product of Example 6 made by the method of the preferred embodiment;

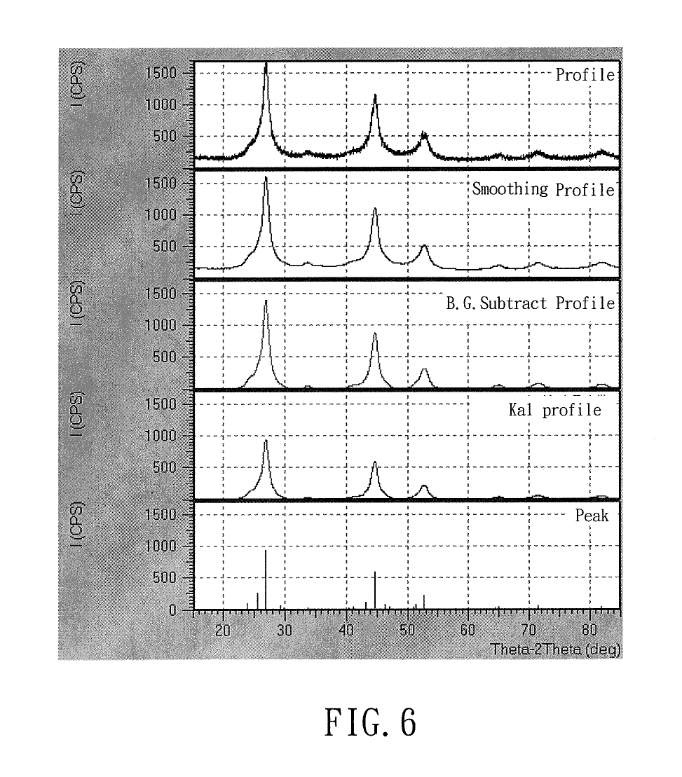

FIG. 7 shows an X-ray diffraction pattern of the final product of Example 7 made by the method of the preferred embodiment;

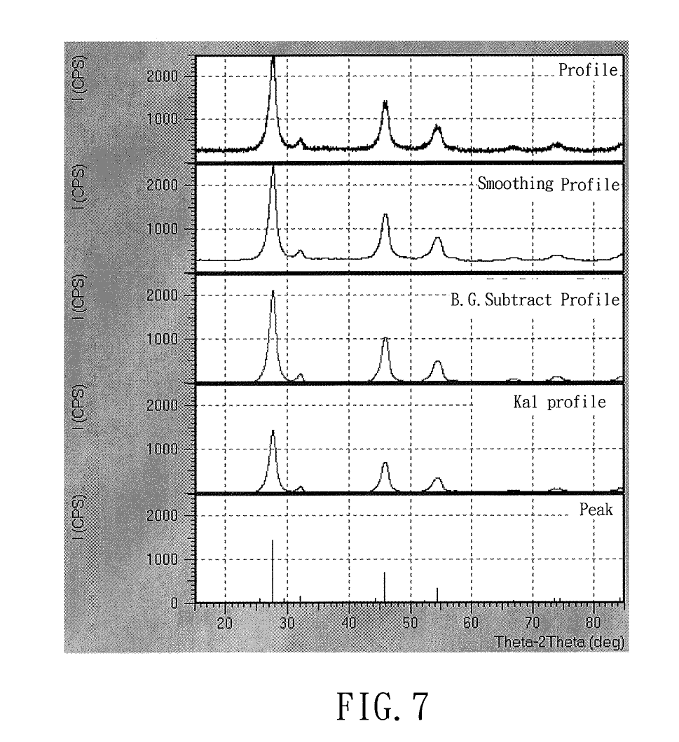

FIG. 8 shows an X-ray diffraction pattern of the final product of Example 8 made by the method of the preferred embodiment;

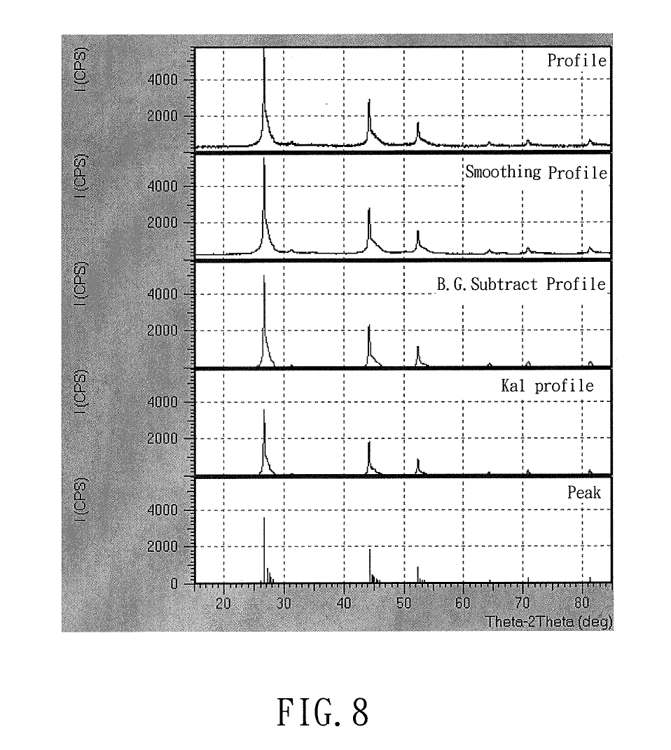

FIG. 9 shows an X-ray diffraction pattern of the final product of Example 9 made by the method of the preferred embodiment;

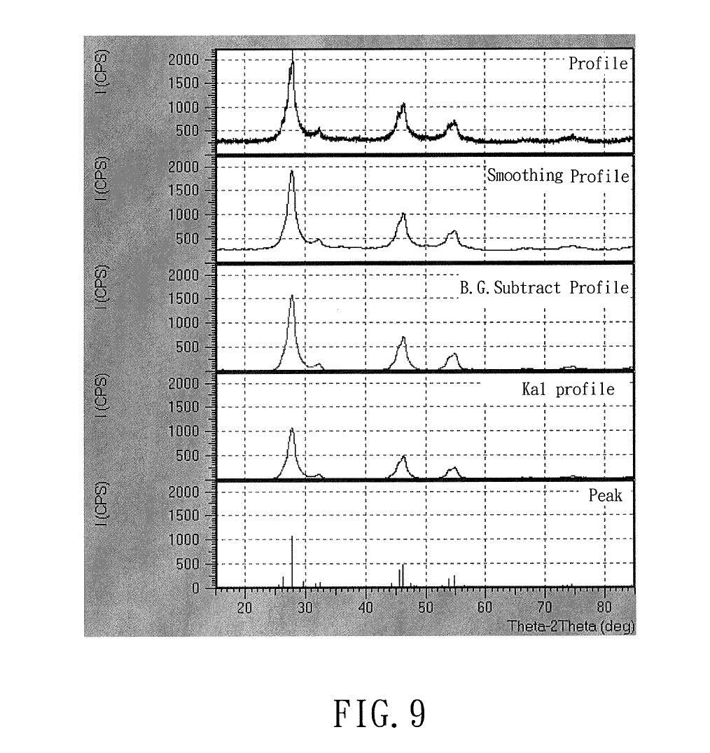

FIG. 10 shows an X-ray diffraction pattern of the final product of Example 10 made by the method of the preferred embodiment;

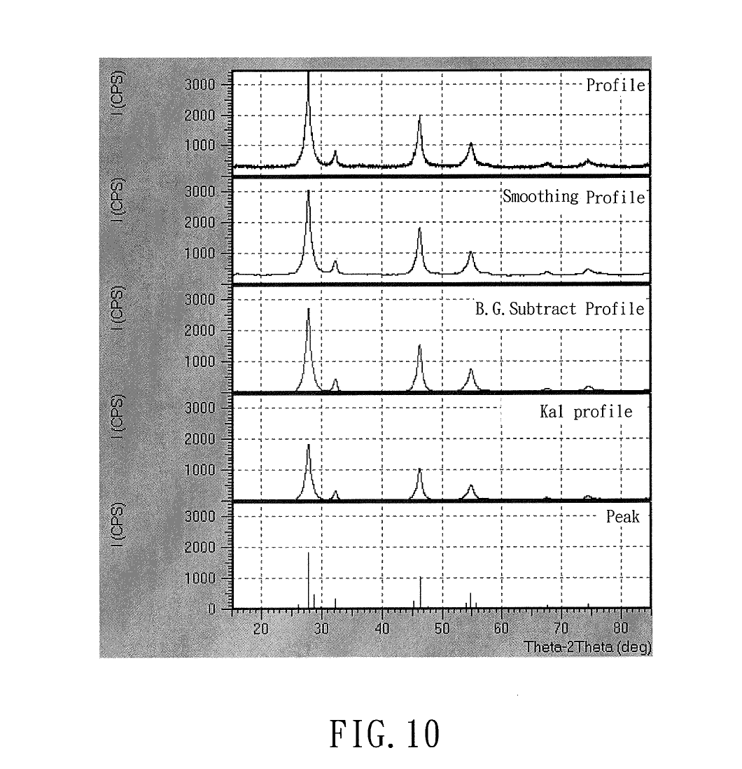

FIG. 11 shows an X-ray diffraction pattern of the final product of Example 11 made by the method of the preferred embodiment;

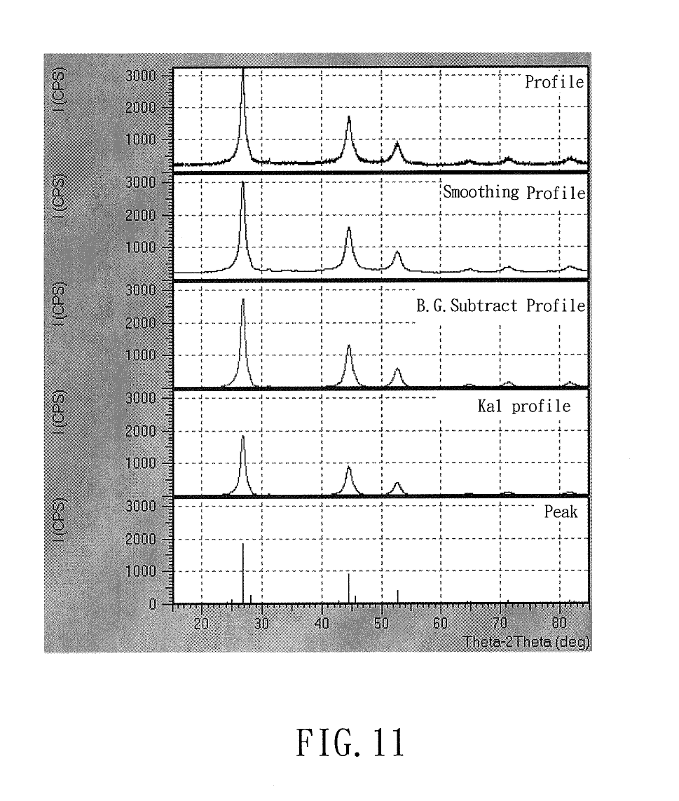

FIG. 12 shows an X-ray diffraction pattern of the final product of Example 12 made by the method of the preferred embodiment; and

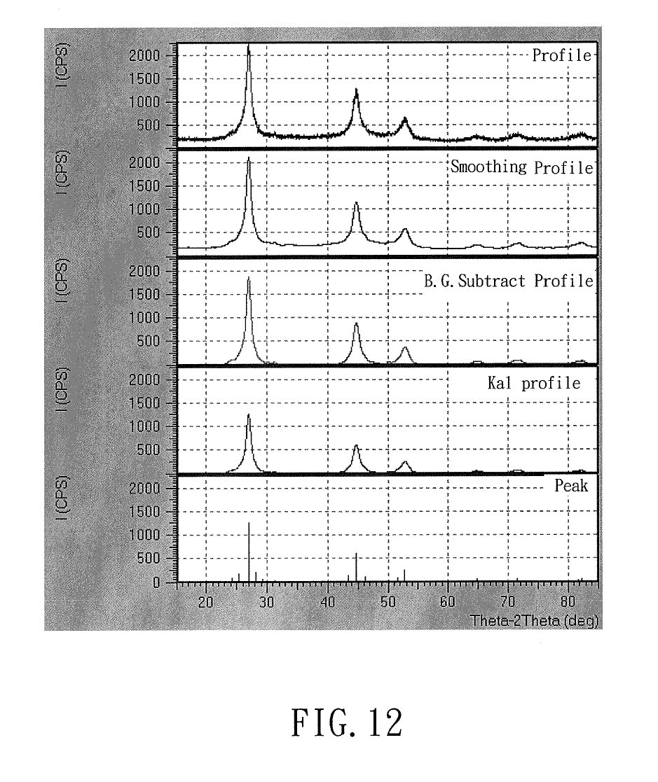

FIG. 13 shows an X-ray diffraction pattern of the final product of Example 13 made by the method of the preferred embodiment.

### DETAILED DESCRIPTION OF THE PREFERRED EMBODIMENT

The preferred embodiment of a method for making a chalcopyrite-type compound according to this invention includes reacting a reaction mixture in a solvent in a closed reactor (not shown) under a reaction temperature and a reaction pressure to form the chalcopyrite-type compound. The reaction mixture includes at least one first compound and at least one second compound. The first compound is any compound containing M¹ and A. The second compound is any compound containing M² and A. M¹ is selected from Cu, Au, Ag, Na, Li and K, M² is selected from In, Ga, Al, Ti, Zn, Cd, Sn, Mg, and combinations thereof, and A is selected from S, Se, Te, and combinations thereof. The reaction temperature preferably ranges from 130-280° C., and the reaction pressure is built up in accordance with the reaction temperature and is preferably greater than 3 Kg/cm². More preferably, the reaction temperature ranges from 135-210° C. and the reaction pressure ranges from 4-20 Kg/cm².

Suitable examples of the solvent are alkylamines, dimethyl formamide(DMF), N-methylpyrrolidone (NMP), dimethyl sulfoxide (DMSO), oleylamine, glycerol, and ethyleneglycol. Preferably, the solvent is an alkylamine, and more preferably, the solvent is ethylenediamine.

The method of the preferred embodiment further comprises filtering the reaction mixture after reaction of the first and second compounds is completed so as to obtain a crude cake of the chalcopyrite-type compound, followed by washing the crude cake with a washing solution containing water, alcohol and ketone, and drying the crude cake.

Preferably, the second compound is prepared by reacting a chemical substance comprising M² and X, in which X represents an anion selected from halide, nitrate(NO₃⁻), and sulfate(SO₄²⁻), with a powder of a material selected from S, Se, Te, and combinations thereof in a solvent solution under reflux condition, filtering the reaction mixture after the reaction is completed so as to obtain a crude cake of the second compound, washing the crude cake of the second compound with a washing solution containing water, alcohol and ketone, and drying the crude cake. Preferably, the solvent solution is a solvent or a mixture of water and a solvent. Examples of the solvent used herein are the same as those mentioned in the reaction step of the reaction mixture.

Preferably, the first compound is prepared by reacting a chemical substance M¹X, in which X represents an anion selected from halide, NO₃⁻, and SO₄²⁻, with the powder of a material selected from S, Se, Te, and combinations thereof in a solvent solution under reflux condition, followed by filtering the reaction mixture after the reaction is completed so as to obtain a crude cake of the first compound, washing the crude cake of the first compound with the washing solution containing water, alcohol and ketone, and drying the crude cake. Preferably, the solvent solution is a solvent or a mixture of water and a solvent. Examples of the solvent used herein are the same as those mentioned in the reaction step of the reaction mixture.

As compared to the method disclosed in U.S. Pat. No. 7,591,990, all the reactants, i.e., the first and second compounds, employed in the method of this invention contain at least one of S, Se, and Te, while only one of the reactants employed in the method of U.S. Pat. No. 7,591,990 is a selenide. This difference enables the method of this invention to make chalcopyrite-type compound with a lower carbon content than that of U.S. Pat. No. 7,591,990.

The merits of the method for making the chalcopyrite-type compound of this invention will become apparent with reference to the following Examples and Comparative Examples. The method of this invention should not be restricted to the following Examples.

### Example 1 (E1)

### Preparation of Cu₂SeₓS₁₋ₓ (M¹A, where M¹ is Cu and A is a Combination of Se and S)

3700 ml of ethylenediamine was added into a reactor. 179 g of Se powder and 57 g of thiourea were added into the reactor with stirring. The mixture in the reactor was stirred for 5 minutes. 500 g of CuCl was slowly added into the reactor with stirring. The mixture was heated to a boiling point thereof with stirring for reaction of the mixture to take place. The reaction of the mixture lasted under reflux condition for 50 hrs. The mixture was filtered to obtain a crude cake after the reaction was completed and the mixture was cooled. The crude cake was washed with a solution containing a large amount of water, 2 L of ethanol and 2 L of acetone, followed by drying at a temperature of 200° C. A dark blue powder (product (a)) having a formula of Cu₂Se_{0.75}S_{0.25} was obtained.

### Preparation of In₂(Se_{y}S_{1-y})₃ (M²A, where M² is In and A is a Combination of Se and S)

4100 ml of ethylenediamine was added into a reactor. 152.4 g of Se powder and 20.7 g of sulfur were added into the reactor with stirring. The mixture in the reactor was stirred for 5 minutes. 600 g of InCl₃.4H₂O was slowly added into the reactor with stirring. The mixture was heated to a boiling point thereof with stirring for reaction of the mixture to take place. The reaction of the mixture lasted under reflux condition for 50 hrs. The mixture was filtered to obtain a crude cake after the reaction was completed and the mixture was cooled. The crude cake was washed with a solution containing a large amount of water, 2 L of ethanol and 2 L of acetone, followed by drying at a temperature of 200° C. An orange powder (product (b)) having a formula of In₂(Se_{0.75}S_{0.25})₃ was obtained.

### Preparation of M¹M²(SeₓS₁₋ₓ)₂ (M¹M²A)

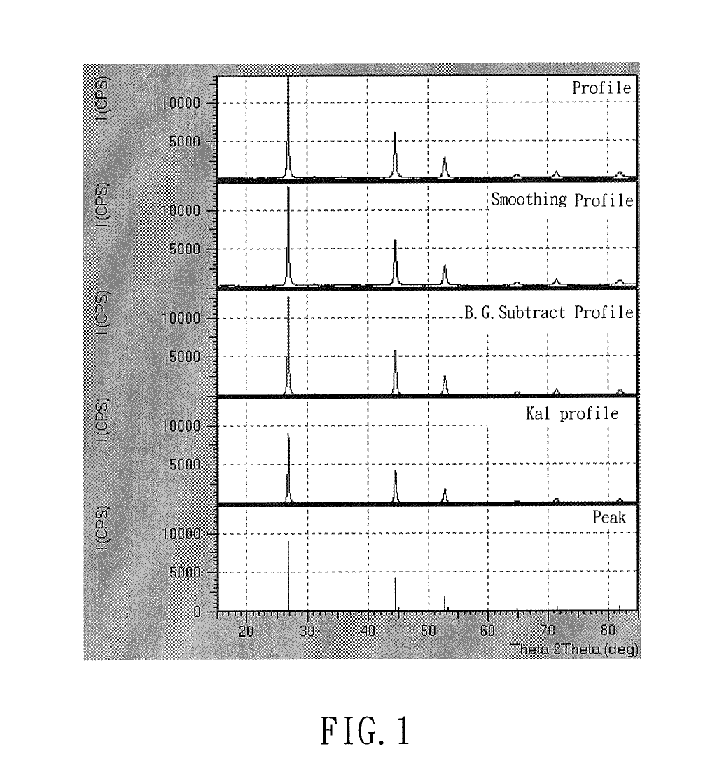

400 ml of ethylenediamine was added into a reactor. 16.4 g of product (a) and 36.4 g of product (b) were added into the reactor with stirring. The reactor was closed. The mixture in the closed reactor was stirred for 5 minutes before heating and was subsequently heated to 210° C. (the pressure in the reactor was built up to 20 Kg/cm² due to the heating) with stirring for reaction of the mixture to take place. The reaction of the mixture lasted for 30 hrs. The mixture was filtered to obtain a crude cake after the reaction was completed and the mixture was cooled. The crude cake was washed with a solution containing a large amount of water, 2 L of ethanol and 2 L of acetone, followed by drying at a temperature of 200° C. A final product of a black powder having a formula of CuIn(Se_{0.75}S_{0.25})₂ (or CuInSe_{1.5}S_{0.5}) was obtained. The production yield was 81%. Elemental analysis shows that the black powder contains an impurity of 0.4 wt % of carbon. FIG. 1 shows the X-ray diffraction (XRD) pattern of the black powder of Example 1.

### Examples 2-6 (E2-E6)

The procedures of preparing M¹M² (SeₓS₁₋ₓ)₂ (M¹M²A) of Examples 2-6 were similar to those of Example 1, except for the reactants, the amounts of the reactants employed, and the reaction temperature and the reaction pressure.

Table 1 shows the amounts of the reactants employed, the reaction temperature and the reaction pressure, the reaction time, the product impurity, the production yield and the formula of the final product for Examples 1 to 6(E1-E6).

TABLE 1

| Example | E1 | E2 | E3 |
|---|---|---|---|
| Reactant 1 | In₂Se_{2.25}S_{0.75} | In₂Se_{2.25}S_{0.75} | In₂Se_{0.75}S_{2.25} |
| weight, g | 36.4 | 20 | 20 |
| Reactant 2 | Cu₂Se_{0.75}S_{0.25} | Cu₂Se | Cu₂Se_{0.25}S_{0.75} |
| weight, g | 16.4 | 8.1 | 6.7 |
| Reactant 3 | n/a | n/a | n/a |
| weight, g | | | |
| Reaction | 210 | 135 | 180 |
| temperature, ° C. | | | |
| Reaction | 20 | 4 | 16 |
| pressure, | | | |
| Kg/cm² | | | |
| Reaction time, | 30 | 30 | 30 |
| hr | | | |
| Final product | CuIn(Se_{0.75}S_{0.25})₂ | CuInSe_{1.62}S_{0.38} | CuInSe_{0.5}S_{1.5} |
| Yield, % | 81 | 82 | 80 |
| Impurity(C, | 0.4 | 0.28 | 0.44 |
| wt %) | | | |
| Example | E4 | E5 | E6 |
| Reactant 1 | In₂S₃ | In₂Se₃ | In₂Se₃ |
| weight, g | 20 | 20 | 20 |
| Reactant 2 | Cu₂Se_{0.25}S_{0.75} | CuSe | CuSe |
| weight, g | 8.9 | 6.1 | 3 |
| Reactant 3 | n/a | n/a | InSe |
| weight, g | | | 4.1 |
| Reaction | 190 | 240 | 260 |
| temperature, ° C. | | | |
| Reaction | 19 | 24 | 28 |
| pressure, | | | |
| Kg/cm² | | | |
| Reaction time, | 30 | 30 | 30 |
| hr | | | |
| Final product(c) | CuInSe_{0.12}S_{1.88} | CuIn₂Se_{3.5} | CuIn₅Se₈ |
| Yield, % | 81 | 78 | 79 |
| Impurity (C, | 0.49 | 0.57 | 0.65 |
| wt %) | | | |

### Examples 7-12 (E7-E12)

Examples 7-12 correspond respectively to Examples 1-6 (i.e., Examples 7-12 use the same reactants and obtaining the same product as those of Examples 1-6, except for the operating conditions). Preparation of M¹M² (SeₓS₁₋ₓ)₂ (M¹M²A) for each of Examples 7-12 was conducted at a boiling temperature (114-118° C.) of the reaction mixture under reflux condition for about 50 hours.

Table 2 shows the reaction time, the production yield, the formula of the product (c) and the product impurity for Examples 7 to 12(E7-E12).

TABLE 2

| Example | E7 | E8 | E9 |
|---|---|---|---|
| Reaction | 114-118 | 114-118 | 114-118 |
| temperature, ° C. | (reflux) | (reflux) | (reflux) |
| Reaction | 1.03(1 atm) | 1.03(1 atm) | 1.03(1 atm) |
| pressure, | | | |
| Kg/cm² | | | |
| Reaction time, | 50 | 50 | 50 |
| hr | | | |
| Final product | CuIn(Se_{0.75}S_{0.25})₂ | CuInSe_{1.62}S_{0.38} | CuInSe_{0.5}S_{1.5} |
| Yield, % | 79 | 80 | 82 |
| Impurity, | 2.22 | 1.79 | 1.76 |
| (C, wt %) | | | |
| Example | E10 | E11 | E12 |
| Reaction | 114-118 | 114-118 | 114-118 |
| temperature, ° C. | (reflux) | (reflux) | (reflux) |
| Reaction | 1.03 | 1.03 | 1.03 |
| pressure, | | | |
| Kg/cm² | | | |
| Reaction time, | 50 | 50 | 50 |
| hr | | | |
| Final product | CuInSe_{0.12}S_{1.88} | CuIn₂Se_{3.5} | CuIn₅Se₈ |
| Yield, % | 83 | 78 | 76 |
| Impurity, | 1.87 | 2.58 | 2.01 |
| (C, wt %) | | | |

### Example 13 (E13)

### Preparation of M¹M² (SeₓS₁₋ₓ)₂ (M¹M²A)

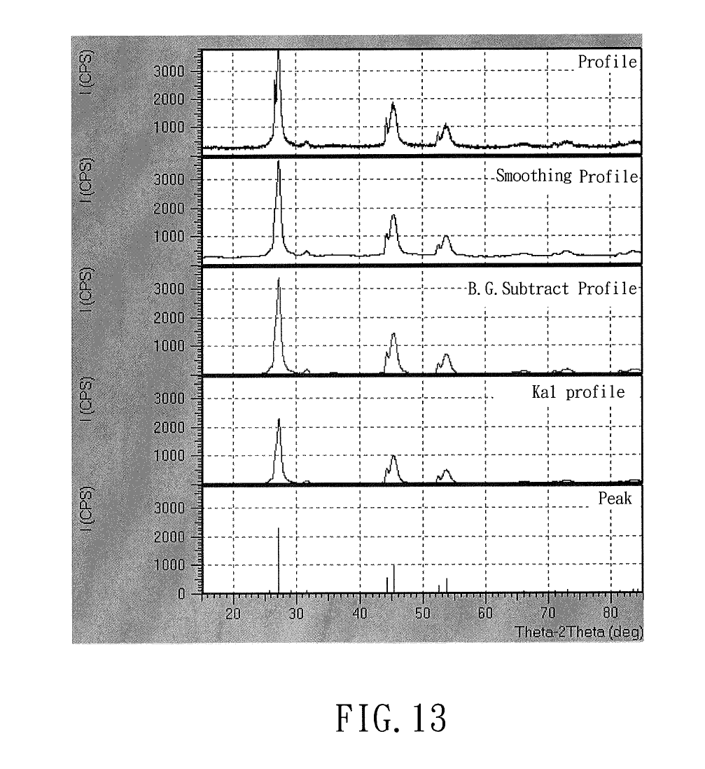

370 ml of ethylenediamine was added into a reactor. 50 g In₂Se_{0.75}S_{2.25} and 24.3 g Cu₂Se were added into the reactor with stirring. The reactor was closed. The mixture in the closed reactor was stirred for 5 minutes before heating and was subsequently heated to 130° C. (the pressure in the reactor was built up to 2.5 Kg/cm² due to the heating) with stirring for reaction of the mixture to take place. The reaction of the mixture lasted for 30 hrs. The mixture was filtered to obtain a crude cake after the reaction was completed and the mixture was cooled. The crude cake was washed with a solution containing a large amount of water, 2 L of ethanol and 2 L of acetone, followed by drying at a temperature of 200° C. A final product of a black powder having a formula of CuInSe_{0.88}S_{1.12} was obtained. The production yield was 82%. Elemental analysis shows that the black powder contains an impurity of 2.26 wt % of carbon. FIG. 13 shows the X-ray diffraction (XRD) pattern of the black powder of Example 13.

In comparison, the final products of Examples 1-6 have an impurity of less than 0.7 wt % (0.28-0.65 wt %), while the final products of Examples 7-13 have an impurity of greater than 1.7 wt % (1.76-2.58 wt %). Example 2 (which has a reaction temperature of 135° C. and a reaction pressure of 4 Kg/cm²) has a lowest impurity content. In addition, the reaction time for Examples 7-12 to reach the production yield thereof is about twice of Examples 1-6.

From the results of Examples 1-13, when the reaction temperature is less than 130° C. and the reaction pressure is less than 3 Kg/cm², the impurity (carbon content) contained in the chalcopyrite-type compound thus formed will be considerably increased. In addition, when the reaction temperature is greater than 280° C., the reaction pressure corresponding to the reaction temperature will be too high, which can result in safety concerns.

With the invention thus explained, it is apparent that various modifications and variations can be made without departing from the spirit of the present invention. It is therefore intended that the invention be limited only as recited in the appended claims.

What is claimed is:

1. A method for making a chalcopyrite-type compound, comprising:
reacting a reaction mixture in a solvent under a reaction temperature and a reaction pressure to form the chalcopyrite-type compound;
wherein the reaction temperature ranges from 130-280° C. and the reaction pressure is greater than 3 Kg/cm²; and
wherein the reaction mixture includes at least one first compound and at least one second compound, the first compound containing M¹ and A, the second compound containing M² and A, in which M¹ is selected from Cu, Au, Ag, Na, Li and K, M² is selected from In, Ga, Al, Ti, Zn, Cd, Sn, Mg, and combinations thereof, and A is selected from S, Se, Te, and combinations thereof.

2. The method of claim 1, wherein the reaction temperature ranges from 135-210° C. and the reaction pressure ranges from 4-20 Kg/cm².

3. The method of claim 1, further comprising preparing the second compound by reacting a chemical substance containing N² with a powder of a material selected from S, Se, Te, and combinations thereof in the solvent under reflux condition.

4. The method of claim 3, wherein the solvent is N-methylpyrrolidone, dimethyl sulfoxide, oleyamine, glycerol, and ethyleneglycol.

5. The method of claim 4, wherein the solvent is ethylenediamine.

6. The method of claim 1, further comprising preparing the first compound by reacting a chemical substance containing M¹ with a powder of a material selected from S, Se, Te, and combinations thereof in the solvent under reflux condition.
